(19) United States
(12) Patent Application Publication
(10) Pub. No.: US 2014/0046506 A1
(43) Pub. Date: Feb. 13, 2014

(54) METHOD OF AUTONOMOUS MOVEMENT OF A VEHICLE IN A PARKING AREA

(71) Applicant: Audi AG, Ingolstadt (DE)

(72) Inventors: Michael Reichel, Ingolstadt (DE); Mohamed Essayed Bouzouraa, Ingolstadt (DE)

(73) Assignee: Audi AG, Ingolstadt (DE)

(21) Appl. No.: 13/963,536

(22) Filed: Aug. 9, 2013

(30) Foreign Application Priority Data
Aug. 11, 2012 (DE) 10 2012 015 968.4

(51) Int. Cl. B62D 15/02

(52) U.S. Cl. CPC B62D 15/0285
USPC 701/2

(57) ABSTRACT

In a method of autonomous driving a vehicle on a parking area, a movement of a vehicle is controlled by an external stationary control device which is located in or in vicinity of the parking area and capable of steering the vehicle autonomously to or from an assigned parking space. An impending or actual collision with another moving or parked vehicle is detected by at least one sensor of the vehicle; and data generated by the sensor is analyzed by an evaluation unit. In response to the situation at hand, the control device makes a behavioral decision, such as, e.g., triggering an alert signal or maneuvering the vehicle.

### CROSS-REFERENCES TO RELATED APPLICATIONS

This application claims the priority of German Patent Application, Serial No. 10 2012 015 966.4, filed Aug. 11, 2012, pursuant to 35 U.S.C. 119(a)-(d), the content of which is incorporated herein by reference in its entirety as if fully set forth herein.

### BACKGROUND OF THE INVENTION

The present invention relates to a method of autonomous movement of a vehicle in a parking area.

The following discussion of related art is provided to assist the reader in understanding the advantages of the invention, and is not to be construed as an admission that this related art is prior art to this invention.

Vehicles are already on the market that are equipped with a parking assist which assists the driver in the task of steering the vehicle into or out of a parking spot. These automated parking maneuvers are monitored by a driver who initiates certain actions. Such actions involve an active actuation of a vehicle key or actuation of a gas pedal or brake pedal.

In order to make autonomous parking in a parking area commercially viable, there has to be an improvement in the utilization of available space over conventional parking, when a driver parks the vehicle by himself or herself. In addition, it must be ensured that minor or serious collisions are recorded and documented. Such incidents cannot be entirely ruled out because vehicles with different technical features are moved in the parking area.

It would therefore be desirable and advantageous to provide an improved method for autonomous movement of a vehicle in a parking area to obviate prior art shortcomings and to make it commercially viable.

### SUMMARY OF THE INVENTION

According to one aspect of the present invention, a method of autonomous driving a vehicle in a parking area includes controlling a movement of a vehicle using an external stationary control device located in or in vicinity of the parking area to steer the vehicle autonomously to or from an assigned parking space, detecting an impending or actual collision with another moving or parked vehicle by at least one sensor of the vehicle, analyzing data generated by the sensor by an evaluation unit, and taking a situation-dependent behavioral decision in response to the analyzed data, using the control device.

The method according to the present invention is based on a detection of an impending collision or collision that has already happened between a moving vehicle and a parked vehicle, with the detection being controlled by the external control device. As sensor or sensors, the use of on-board sensors of the moving vehicle, which are part of driver assistance systems, may advantageously be contemplated. Examples for such sensor(s) include ultrasonic sensor, laser sensor, radar sensor, optical sensors to measure operating time (PMD), camera for capturing video sequences with respective evaluation algorithms, and sensors to prevent or detect theft. Sensor data generated by the sensor or sensors are transmitted to the evaluation unit which is part of the external control device. The control device is advantageously located stationary in or in vicinity of the parking area. Of course, other configurations are conceivable as well, such as the placement of an external control device at a location that is far removed from the parking area so that sensor data is then transmitted from the parking area to the external control device via a communication link.

As described above, the sensor data are analyzed by the evaluation unit. Subsequently, the external control device takes a situation-dependent behavioral decision to initiate an action that best suits the situation. For example, when detecting an imminent collision, measures are immediately taken to prevent an accident. In the event, a collision has in fact taken place, measures involving documentation and information are initiated. In the first case, accident avoidance is the primary objective, whereas in the second case, documentation of an actual accident is the primary focus, possibly also damage control.

According to another advantageous feature of the present invention, the behavioral decision may include triggering of an alert signal, such as warning signal or alarm signal. This alert signal warns the other vehicle about a vehicle that is steered by the external control device. As a result, there is the possibility that the other vehicle recognizes an impending collision and may intervene to initiate possible automatic actions for accident avoidance. The alert signal may involve flashing, honking, a light signal, or a radio signal. Combinations of such alert signals are, of course, possible as well. As an alternative, or in addition, the behavioral decision may include maneuvering the vehicle by the external control device. In this way, a moving or standing vehicle may be steered away from a danger zone before a collision with another vehicle can occur.

According to another advantageous feature of the present invention, a recording unit may be used to record information, such as data generated by the sensor, analyzed sensor data, behavioral decision, or other data relevant to the method. The recording unit is able to execute measures for documentation and information following an accident. Primarily, vehicle-own sensor signals and optionally further characteristic values such as time, locale, etc. are recorded. In addition, the behavioral decision may also involve notification of an owner of the vehicle and/or supervisory or service personnel. Likewise, other traffic participants or other service providers such as repair service or towing service or other authority may be notified. The recording unit can be arranged in the vehicle or may also be part of the external control device.

According to another advantageous feature of the present invention, the behavioral decision may include maneuvering the vehicle involved in the situation of impending or actual collision with another moving or parked vehicle to a safe state. The maneuver may especially involve decelerating the vehicle, optionally until the vehicle comes to a halt. The external control device may hereby be configured in such a way that a further endangerment or damage of vehicles is prevented.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a driverless vehicle for movement in a parking space; and

FIG. 2 is a schematic top view of a situation during execution of a method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

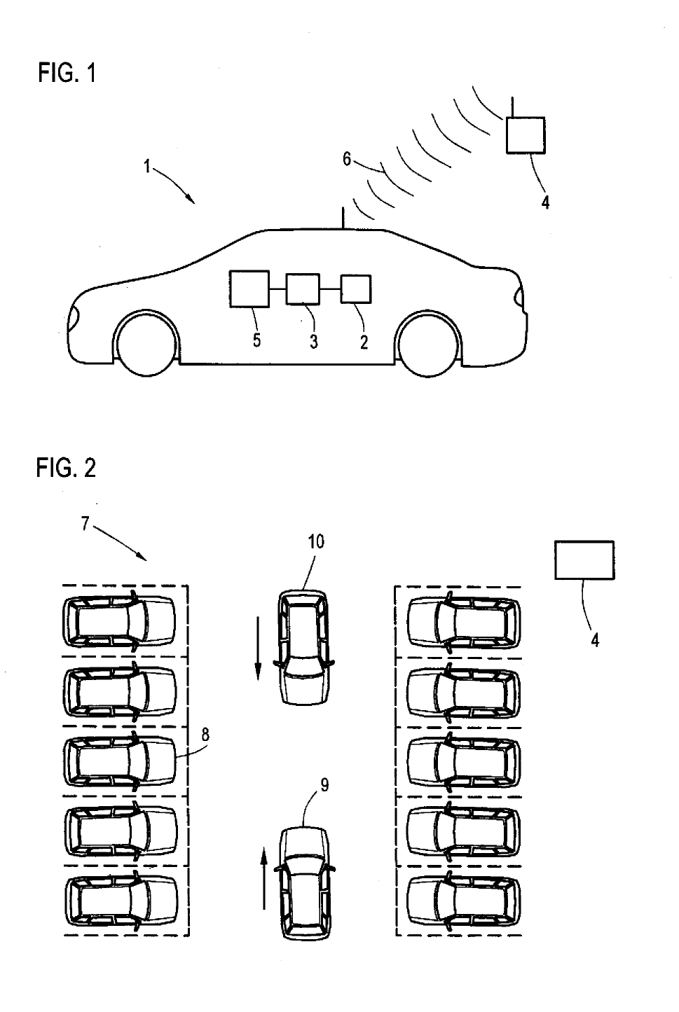

Turning now to the drawing, and in particular to FIG. 1, there is shown a driverless vehicle, generally designated by reference numeral 1, for movement in a parking space. The vehicle 1 includes several sensors 2 capable of monitoring the environment of the vehicle 1. The sensors 2 are coupled with an evaluation unit 3 which is configured as part of the vehicle 1. Analyzed sensor data is transmitted to an external control device 4 which is configured to render a behavioral decision in response to the sensor data received from the evaluation unit 3. The evaluation unit 3 is coupled to a communication device 5 provided in the vehicle 1 and connectable to the external control device 4 via a wireless communication link 6 for exchange of data and information.

The external control device 4 is configured for access to the vehicle 1 in order to steer the vehicle 1 to or from an assigned parking spot. As the movement of several vehicles 1 is being executed autonomously, i.e. driverless, the available area can be better utilized in comparison to a conventional parking area, where parking is controlled by the drivers. Autonomous parking eliminates the need for opening of doors or hatches so that the individual vehicles can be parked in close proximity to one another.

FIG. 2 shows a schematic top view of a situation during execution of a method for driverless steering of a vehicle in a parking area 7 where a great number of vehicles 8 are parked. Movement of individual vehicles in the parking area is autonomous, using the external control device 4 which has access to the individual vehicles in order to steer the vehicles to and from the assigned parking spot.

FIG. 2 shows two vehicles 9, 10 being maneuvered in the parking area 7, with the arrows indicating the movement direction of the vehicles. The two vehicles 8, 9 are on a collision course, i.e. the trajectories touch one another.

Sensors 2 in the vehicle 9 sense the environment so that the approaching vehicle 10 is detected. After analyzing the sensor data in the evaluation unit 3, the external control device 4 is informed and takes a behavioral decision in response to the situation at hand. In the exemplary situation of FIG. 2, the external control device 4 decelerates the vehicle 9 and simultaneously triggers warning signals in the form of optical signals and radio signals which can be received by the vehicle 10. Vehicle 10 is also equipped with sensors 2 for monitoring the environment and with an evaluation unit 3. As the vehicle 10 may be of different type and make and constructed by a different manufacturer than vehicle 9, the two vehicles 9, 10 differ as to the speed with which the dangerous situation is recognized. Vehicle 10 thus also sends out information to the external control device 4 which takes a suitable behavioral decision with respect to the vehicle 10. In the illustrated case of FIG. 2, vehicle 10 is also decelerated and the external control device 4 subsequently establishes a different route so that a collision of the vehicles 9, 10 is avoided.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of autonomous driving a vehicle in a parking area, comprising:
controlling a movement of a vehicle using an external stationary control device located in or in vicinity of the parking area to steer the vehicle autonomously to or from an assigned parking space;
detecting an impending or actual collision with another moving or parked vehicle by at least one sensor of the vehicle;
analyzing data generated by the sensor by an evaluation unit; and
taking a situation-dependent behavioral decision in response to the analyzed data, using the control device.

2. The method of claim 1, wherein the behavioral decision includes triggering an alert signal selected from the group consisting of warning signal and alarm signal.

3. The method of claim 2, wherein the alert signal involves an action selected from the group consisting of flashing, honking, light signal, and radio signal.

4. The method of claim 1, wherein the behavioral decision includes maneuvering the vehicle by the external control device.

5. The method of claim 1, further comprising recording information selected from the group consisting of data generated by the sensor, analyzed sensor data, behavioral decision, and other data relevant to the method, using a recording unit.

6. The method of claim 1, wherein the behavioral decision includes notification of a person selected from the group consisting of owner of the vehicle, supervisor, and service personnel.

7. The method of claim 1, wherein the behavioral decision includes maneuvering the vehicle involved in the situation of impending or actual collision with another moving or parked vehicle to a safe state.

8. The method of claim 7, wherein the maneuvering step includes decelerating the vehicle.

9. The method of claim 7, wherein the maneuvering step includes decelerating the vehicle to come to a halt.
